(19) United States
(12) Patent Application Publication
(10) Pub. No.: US 2011/0139977 A1
(43) Pub. Date: Jun. 16, 2011

(54) MATRIX-ASSISTED LASER DESORPTION WITH HIGH IONIZATION YIELD

(75) Inventors: Andreas Haase, Bremen (DE); Jens Höhndorf, Bremen (DE)

(73) Assignee: BRUKER DALTONIK GMBH, Bremen (DE)

(21) Appl. No.: 13/029,778

(22) Filed: Feb. 17, 2011

Related U.S. Application Data
(62) Division of application No. 12/177,434, filed on Jul. 22, 2008.

(30) Foreign Application Priority Data
Jul. 31, 2007 (DE) 10 2007 035 826.3
Sep. 12, 2007 (DE) 10 2007 043 456.3

(51) Int. Cl. B01D 59/44; H01J 27/24

(52) U.S. Cl. 250/282; 250/424

(57) ABSTRACT

Analyte ions are generated in an ion source by matrix-assisted laser desorption (MALDI) in which laser light pulses have significantly less than one nanosecond duration, focal diameters of less than twenty micrometers and energy densities such that only about one picogram of sample is desorbed per pulse of laser light and per laser spot. An unexpectedly high degree of ionization of analyte molecules is produced for selected matrix substances. Many laser spots can be generated side-by-side from a single laser light pulse for use with MALDI time-of-flight mass spectrometers. Applying pulses with a repetition rate of around 50 kilohertz and moving the sample or guiding the laser light beam so each laser light pulse impinges on a cool sample spot allows the ion source to be used with spectrometers that require a constant ion current.

### BACKGROUND

The invention relates to the generation of analyte ions from solid samples on surfaces by matrix-assisted laser desorption (MALDI). One important type of ionization for biomolecules is ionization by matrix-assisted laser desorption (MALDI), which was developed by M. Karas and F. Hillenkamp, in particular, some twenty years ago, and for whose basic research Koichi Tanaka was awarded the 2002 Nobel Prize. MALDI ionizes the biomolecules, which are located in highly diluted form in a mixture with molecules of a matrix substance in samples on sample supports, by bombarding them with pulses of laser light. The ratio of analyte molecules to matrix molecules is, at the most, approximately one thousand to ten thousand, although the analyte substances can form a mixture in which concentration ratios covering several orders of magnitude may pertain between the different analyte substances to be measured.

MALDI is a competing technique to electrospray ionization (ESI), which ionizes analyte molecules dissolved in a liquid, and can hence be easily coupled to separation techniques such as liquid chromatography or capillary electrophoresis. MALDI has many advantages, however. Hundreds of samples can be applied to a single sample support. Pipetting robots are available for this purpose. It takes only fractions of seconds to transport a neighboring sample with the sample support into the focus of a UV pulsed laser; as much time as is ever needed is then available for the analysis of this sample, the only limit being when the sample is completely exhausted. This sets MALDI very favorably apart from electrospray ionization, which provides only a very slow sample change and, when used in conjunction with chromatography, necessarily limits the analysis time to the duration of the chromatographic peak. MALDI is, for example, ideal for the identification of tryptically digested proteins which have been separated by 2D gel electrophoresis and whose separated fractions have been processed into separate MALDI samples. MALDI analysis of peptides separated by liquid chromatography and applied to MALDI sample supports is also gaining ground (“HPLC MALDI”). Of particular interest is the use of MALDI in the imaging mass spectrometry of histologic thin sections, which can determine the spatial distribution of individual proteins and also of individual pharmaceuticals or their metabolites.

The lasers usually used for MALDI are UV lasers providing pulses of laser light beams of a few nanoseconds duration, focused by lenses onto focal spots of between approximately 100 and 200 micrometers diameter. The focusing adjustment is deliberately chosen to give these diameters; the “focal spot” on the sample does not correspond to the achievable minimum focal diameter of the beam of laser light. The ions of every single pulse of laser light are accelerated axially into a time-of-flight path in specially designed MALDI time-of-flight mass spectrometers; after passing through the flight path, the ions are fed to a detector, which measures the mass-dependent arrival time of the ions and their quantity, and then records the digitized measured values in the form of a time-of-flight spectrum. The laser light pulses used here have repetition rates of up to 2 kilohertz approximately. The measured values of a few hundred sequentially obtained time-of-flight spectra of the ions from the individual pulses of laser light are added together to form a sum spectrum: this is subjected to a peak separation procedure, and the list of the time-of-flight peaks is converted into a list of masses and their intensities using a calibration curve. This list is called a “mass spectrum”.

One disadvantage of this usual MALDI method, however, is that it ionizes only around one ten thousandth of the analyte molecules. Only 60 or so analyte ions are obtained from one attomol of an analyte substance, i.e. from approx. 600,000 molecules. The rest are not ionized; an unknown proportion of the remaining molecules are possibly contained in ejected lumps or molten splashes of matrix substance and are completely excluded from ionization, while, on the other hand, an also unknown proportion of the analyte molecules are simply not ionized in the laser desorption process.

Matrix-assisted laser desorption has, until now, mainly been performed in a high vacuum with direct axial injection of the ions into the flight path of a specially designed MALDI time-of-flight mass spectrometer. The starting point (with few exceptions) is solid sample preparations on a sample support. The samples consist primarily of small crystals of the matrix substance, to which a small proportion (only around one hundredth of one percent at most) of molecules of the analyte substances are added. The “analyte substances” themselves can consist of a mixture of diverse analyte substances. The analyte molecules are embedded individually into the crystal lattice of the matrix crystals, or are located in crystal boundary surfaces. The samples prepared in this way are irradiated with short pulses of UV laser light. The duration of the pulses is usually between three and ten nanoseconds. This produces vaporization clouds which contain ions of the matrix substance as well as some analyte ions. Some of the analyte ions are already contained in the solid sample in ionized form; some are created directly in the explosive vaporization process in the hot plasma; and a third fraction is formed in the expanding cloud by proton transfer in reactions with the matrix substance ions.

The very detailed review article “The Desorption Process in MALDI” by Klaus Dreisewerd (Chem. Rev. 2003, 103, 395-425) reports on the influences of many parameters, such as spot diameter, laser light pulse duration and energy density, on the desorption and the generation of the matrix ions and analyte ions. Although the influences of many of these parameters are not independent of each other, the step of carefully varying all the parameters in relation to each other has been almost entirely neglected. It has been reported, for example, that the laser light pulse duration of between 0.55 and 3.0 nanoseconds has no influence on ion formation; but the spot diameter here was neither varied nor even stated. On the other hand, the energy density threshold for the initial occurrence of ions has been investigated for varying spot diameters without, however, investigating the profile of the energy density in the laser spot, which, according to our own investigations, is of immense importance. According to this literature source, incidentally, this threshold increases very strongly with decreasing spot diameters: for spot diameters of approx. 10 micrometers, around ten times the energy density (fluence) is required compared to spot diameters of 200 micrometers. We cannot confirm this. Apparently, nothing is elucidated in the literature on the mutual influence of spot diameter and laser pulse duration.

Previous investigations into the MALDI process were, however, adversely affected by un-reproducible sample preparation methods. Usually, droplets with matrix and analyte solution have simply been applied to the sample support plate and dried. These samples were extremely inhomogeneous, and one regularly had to search for spots on the sample (“hot spots”) containing analyte molecules in order to perform an analysis of these substances. Quantitative work was impossible. Most investigations into the MALDI process have been performed with these samples, possibly explaining many of the inconsistencies in these investigations.

Methods are now available for some water-insoluble matrix substances, such as α-cyano-4-hydroxycinnamic acid (CHCA), which can produce thin layers consisting of only a single layer of closely spaced crystals, one micrometer or so in diameter, with very high reproducibility. A predominantly water-based solution of analyte molecules is applied to this thin layer of matrix crystals; the matrix crystals bind the analyte molecules on the surface without being dissolved themselves. The excess solvent can then be removed again by suction after thirty seconds to one minute, thus removing many impurities, such as salts. A large proportion of the analyte molecules are also removed, however, and this needs to be taken into consideration in quantitative investigations. The analyte molecules adsorbed on the surface can also be subsequently embedded into the small matrix crystals if an organic solvent which partially dissolves the matrix crystals is applied after the drying process. After vaporization of this solvent one obtains a very homogeneous sample, which delivers the same ion currents with the same analytical results from every spot. Sample support plates already prepared with thin layers of CHCA are now commercially available. Adequate investigations of the MALDI processes occurring on these thin-layer samples have yet to be published.

Laser desorption, which was previously only used in high vacuum, has for a few years also been used at atmospheric pressure, simplifying the sample introduction but not, as yet, increasing the detection sensitivity. This method is termed AP-MALDI (atmospheric pressure MALDI).

With the introduction of solid-state lasers into the MALDI technology instead of the previously used nitrogen lasers, it was found that the more homogeneous beam profile of these solid-state lasers decreases the ion yield. A method for inhomogeneous profiling has therefore been developed which increases the ion yield even beyond the ion yield of nitrogen lasers. This technique is described in the patent application publication DE 10 2004 044 196 A1 (A. Haase et al.), (patent application GB 2 421 352 A, U.S. Pat. No. 7,235,781 C1).

For other types of mass spectrometer, such as time-of-flight mass spectrometers with orthogonal ion injection (OTOF), it is more favorable to use a continuous ion beam instead of pulsed ion generation. The patent publication WO 99/38 185 A2 (A. N. Krutchinski et al.) has already elucidated a method whereby the ion clouds from the usual MALDI processes were drawn out in RF ion guides and thus converted into ion currents which were at least temporarily constant in order to serve those types of mass spectrometers needing a constant ion current.

Whenever the term “mass of the ions” or simply “mass” is used here in connection with ions, it is always the “mass-to-charge ratio” m/z which is meant, i.e. the physical mass m of the ions divided by the dimensionless and absolute number z of the positive or negative elementary charges which this ion carries.

### SUMMARY

The invention combines parameter values for the desorption process which, in the literature, have not been regarded as favorable for the MALDI process, neither singly nor in combination, but which produce an unprecedentedly high degree of ionization.

By vaporizing sample material from very small sample spots of less than twenty micrometers diameter, preferably less than ten micrometers, and by also using laser light with very short pulse durations of less than one nanosecond, preferably less than 500 picoseconds, only relatively few analyte ions are produced in each laser spot; overall, however, the degree of ionization of the analyte molecules increases to values between one tenth of a percent and one percent when suitable matrix materials are used. This is more than ten times the degree of ionization obtained previously. This results in a ten- to twenty-fold increase in detection sensitivity for the analyte molecules, an unprecedented sensitivity for MALDI. It is advantageous to set such a low energy density that, with every pulse of laser light, only approximately one picogram or less of sample material is vaporized.

For use in normal MALDI time-of-flight mass spectrometers, it is favorable for several laser spots, for example 10 to 20, from each laser light pulse to be generated side by side on the sample so as to provide sufficient ions in each pulse for optimal utilization of the time-of-flight mass spectrometer and its measuring device for ions. Devices for generating several laser spots from a single laser light beam are described in the above-cited patent application publication DE 10 2004 044 196 A1 (A. Haase et al.).

For other types of mass spectrometer which operate more efficiently with a continuous ion beam, for example time-of-flight mass spectrometers with orthogonal ion injection, such a constant ion beam can be achieved by an extremely high repetition rate of the UV laser light pulses of above 20 kilohertz, preferably higher than 50 kilohertz. The desorption clouds generated in quick succession merge into each other in the surrounding vacuum and form the continuous ion current with an ion current strength that is optimal for many mass spectrometers even with only one laser spot per laser light pulse.

If only one laser spot per laser light pulse is generated, the energy supplied to the sample with every pulse of laser light only amounts to fractions of a microjoule; therefore the laser only requires a quite low overall power and can be correspondingly compact.

Such high repetition rates for the laser pulses produce a practically continuous ion beam current, even if individual plasma clouds are generated. In one embodiment, each plasma cloud can expand relatively undisturbed to a diameter of approx. one to two centimeters before the ions are captured by the suction effect of an ion funnel. The neutral gas molecules of the vaporization cloud can be pumped off efficiently. However, the desorption can also take place directly into an RF ion guide. It is favorable to slightly dampen the free expansion of the plasma clouds by introducing ambient gas.

The spots should be moved across the sample between laser shots to allow time for each vaporization crater produced to cool down. If several spots are generated in parallel, the cited patent application describes how such movement can be generated. If single spots are used, moving mirrors can be utilized, for example mirrors moved by piezo effects or galvanic effects, which can also be used in conjunction with movement of the sample support plate.

### BRIEF DESCRIPTION OF THE DRAWINGS

FIG. 1 gives a schematic representation of a time-of-flight mass spectrometer with orthogonal ion injection which is fed with MALDI ions according to this invention. A UV pulsed laser (1) with 60 kilohertz repetition rate delivers finely focused pulses of laser light (2) via a movable mirror (3) onto samples located on a movably mounted sample plate (4) and thus generates expanding plasma clouds (5) containing the analyte ions. These ions can be drawn into an ion funnel and fed in the form of a narrow beam (12) via ion guides (8) and (10) to a time-of-flight mass analyzer, whose pulser (13) accelerates sections of the ion beam via a reflector (15) to an ion detector (16), which measures the ions arriving in sequence according to their mass, in the form of a time profile.

FIG. 2 provides a schematic representation of an ion source with a slightly different design. The sample plate (21) contains samples (22, 23), which can be irradiated by the pulsed UV laser (24) with a rapid succession of laser light pulses (25) by means of a movable mirror (26). The analyte ions (27) contained in the plasma clouds are transmitted by the ion funnel, which consists of individual apertured diaphragms (28), into the ion guides (29) and (31).

FIG. 3 shows a time-of-flight mass spectrometer in which the ions generated from the sample (47) on the sample carrier (41) are accelerated axially through the acceleration diaphragms (48) and into the flight path (49). The laser light pulse from the picosecond UV laser (43) is divided in a divider disk (44) consisting, for example, of an array of Einzel lenses; a large number of very small spots, each less than 20 micrometers in diameter, are irradiated on the sample (47) via lens (45) and movable mirror (46).

### DETAILED DESCRIPTION

While the invention has been shown and described with reference to a number of embodiments thereof, it will be recognized by those skilled in the art that various changes in form and detail may be made herein without departing from the spirit and scope of the invention as defined by the appended claims.

Scarcely any investigations with a reasonable degree of precision relating to the ion yield of the MALDI process are to be found in the literature. This is understandable in view of how difficult it is to perform such investigations: one has to measure a very precisely prepared and weighed sample with constant MALDI parameters until the usually inhomogeneous sample is completely used up. One then has to estimate the often not very precisely known ion transmissions in the individual sections of the mass spectrometer used, calibrate the detector sensitivity, and compute the ion yield from the results of the measurement. This can hardly be achieved satisfactorily for the existing preparation method with dried droplets because the sample is very inhomogeneous.

If one investigates the ion yield of the MALDI process per analyte molecule on thin-layer preparations as a function of spot diameter, laser shot energy and laser light pulse duration relative to each other—which is much simpler to do—then one finds that, surprisingly and contrary to what is widely stated in the literature, the yield is greatly increased by using very short pulses of laser light of much less than one nanosecond and by vaporizing only a minute amount of sample material of less than one picogram in a very small sample area. High yields of analyte ions are thus achieved: it is quite possible that around ten to one hundred times more analyte ions can be generated from the sample than by using conventional parameters. The absolute numbers of analyte ions per laser shot are, however, very low; they amount to only around a few hundred analyte ions for the analyte substance of highest concentration in the sample. In mixtures containing many analyte substances in one sample, all of which are to be analyzed, an analyte ion for those analyte substances which are contained in significantly lower concentrations than the main analyte substances in the sample will only be found in every tenth or hundredth pulse of laser light.

However, without additional measures, this highly efficient type of MALDI is not optimal for the usual MALDI time-of-flight mass spectrometry with axial ion acceleration because the latter technique needs preferably between approx. 2,000 and 10,000 analyte ions per laser shot for satisfactory operation. This MALDI time-of-flight mass spectrometry records the ions of every single laser shot in a separate mass spectrum. Since components of the analyte substances which are present at only one ten thousandth of the concentration of the main component are also to be measured, application of the new technique would mean adding together far more than ten thousand mass spectra to achieve this goal with only one spot per laser light pulse. That would take a long time in mass spectrometric terms, even if it is possible to use a mass spectrometer with a measuring frequency of two kilohertz.

A first favorable embodiment of a mass spectrometer using this invention is therefore to generate not just a single small laser spot from the light beam of a short UV laser light pulse with a duration of far less than one nanosecond, but several laser spots, each with a diameter of less than twenty micrometers, preferably less than ten micrometers, and to accelerate the thus generated larger number of ions axially into the flight path. With five to twenty laser spots, several thousand analyte ions are generated in each laser light pulse in a form that is favorable for axial MALDI time-of-flight mass spectrometry. The generation of several laser spots from one laser light beam is described in detail in the above-cited publication of the patent application DE 10 2004 044 196 A1 (A. Haase et al.).

In FIG. 3 such a time-of-flight mass spectrometer is shown schematically. The beam of the light pulse from the UV laser (43) is multiply divided in a divider disk (44). The divider disk (44) can consist of, for example, a field of small Einzel lenses, which generate a large number of small focal points, which are then focused onto the sample (47) by the lens (45) and the moving mirror (46). In this way a large number of small spots are generated on the sample according to the invention. The sample (47) is located on a sample support plate (41), which can be moved by a movement device (42) in order to bring the various samples on the sample support plate into the light beam, and also to move the spots across the sample between laser light pulses, in addition to the guidance by the moving mirror (46). The ions are formed into an ion beam (49) by the acceleration diaphragms (48), and this beam is focused to the detector (51) via the energy-focusing reflector (50).

In contrast, for a time-of-flight mass spectrometer that operates with orthogonal ion injection, a constant ion current and a normal scanning rate of 5,000 to 10,000 mass spectra per second, the conditions of the method according to the invention are virtually ideal, even with only a single spot per laser light pulse, if a sufficiently high frequency of the laser light pulses is selected. It is therefore a further favorable embodiment to use a laser pulse rate of at least twenty kilohertz, preferably at least fifty kilohertz for this purpose. There are commercially available UV lasers which operate at around 60 kilohertz and with a laser light pulse duration of around 350 picoseconds. Due to their low power, they are very compact. At 60 kilohertz, i.e. with six to twelve laser shots for a mass spectrum, the ion source then provides around one thousand to five thousand analyte ions for one scan. The high mass resolution of these devices means that the most intensive ion signals lie just below the saturation threshold of the ion detector. At the present time, a scanning rate of two gigahertz and a digitization bandwidth of eight bits are normally used. In scanning times of between one tenth of a second and one second, it is thus certainly possible to measure approximately one million to ten million analyte ions; this results in a high dynamic range for this type of measurement.

If, in the future, further developments in electronics lead to significantly higher acceptance rates and larger digitizing bandwidths, corresponding to a higher saturation level, for example eight gigahertz with 12-bit bandwidth, then optical systems could also be used here to focus the pulses of laser light, said systems providing more than one spot per laser light shot by splitting the beam of laser light and therefore considerably increasing the generation rate for ions according to the number of spots.

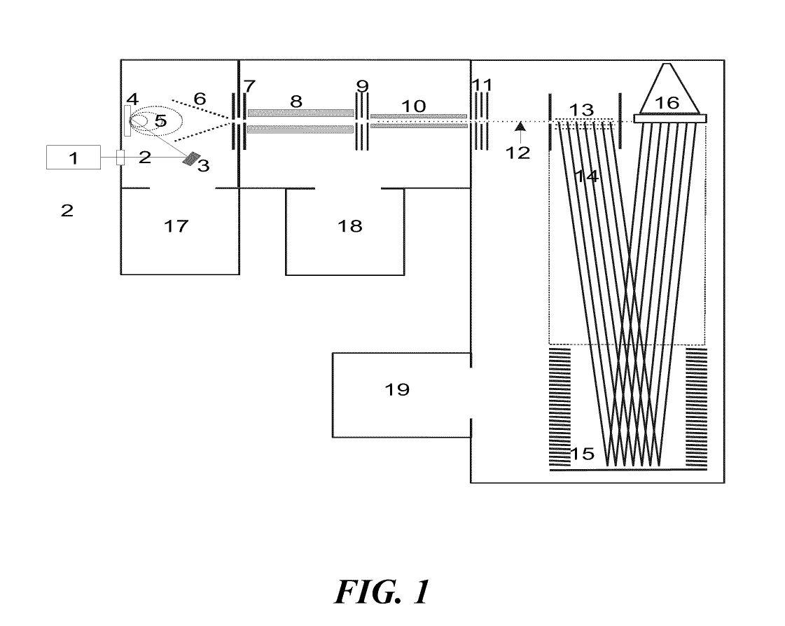

A time-of-flight mass spectrometer with orthogonal ion introduction is schematically shown in FIG. 1 in combination with an ion source according to the invention. A UV pulsed laser (1) with 60 kilohertz repetition rate delivers finely focused laser light pulses (2) onto samples located on a movably mounted sample plate (4). The beam of laser light is focused to a spot diameter of less than twenty micrometers, preferably less than ten micrometers, onto the sample by a lens system, which is not shown here. It is guided by a movable mirror (3), which allows the vaporization spot to be directed to a different location on the sample between laser shots. This generates plasma clouds (5) containing not only background ions, which stem from the matrix material, but also, importantly, the analyte ions, and which expand continuously into the surrounding vacuum.

The ions can be drawn into an ion funnel (6) and fed to a time-of-flight mass analyzer in the form of a narrow beam (12) via lens systems (7, 9, 11) and ion guides (8, 10). The pulser (13) of the analyzer accelerates sections of the ion beam (12) via a reflector (15) to an ion detector (16). The ions arriving in sequence according to their mass form a time profile of the ion current, whose peaks reflect the current profiles of distinct ion masses. The digitization produces sequences of values, each corresponding to a time-of-flight spectrum. It is quite feasible to scan around 5,000 to 10,000 time-of-flight spectra per second in these time-of-flight mass spectrometers with orthogonal ion injection. Successive time-of-flight spectra are added together to form a sum spectrum. The sum spectrum is then processed with a peak recognition computer program and the flight times of the peaks are converted into a mass spectrum with the aid of a calibration curve.

MALDI ionization is also popular for other types of mass spectrometers, for example ion cyclotron resonance Fourier-transform mass spectrometers (ICR-FT-MS) or electrostatic ion traps, because it scans many samples in a short time and because it is decoupled from separation methods. Although these types of mass spectrometer operate in a pulsed mode, a constant ion current is favorable for them, too. The type of MALDI according to the invention—with short pulses of laser light with a very high repetition rate and small amounts of material vaporized—can also be used to advantage here.

UV lasers with a repetition rate of 60 kilohertz, a laser light pulse duration of only 350 picoseconds and relatively low power are commercially available and are ideally suited to these requirements if only a single spot per laser light pulse is to be irradiated. They are very compact compared to other UV pulsed lasers used up to now for MALDI.

The processes in the plasma clouds generated by very short pulses of laser light are apparently very different to those in the laser plasmas previously generated for MALDI. Matrix molecules are, for example, decomposed to a far lesser degree and are far less restructured to highly complex ions with widely differing masses. Significantly less chemical background noise is produced from ions formed from matrix molecule fragments than is the case with conventional MALDI. The ions of the unfragmented matrix substances and their dimers and trimers can be recognized much more clearly in the background noise than is the case with conventional MALDI. The background noise, which exerts strong interference up to a mass of approx. 1,000 Daltons with conventional MALDI, does not reach nearly as far into the mass range of the mass spectra when the short laser light pulses are used. The low level of background noise means that the detection limit is shifted favorably to lower concentrations.

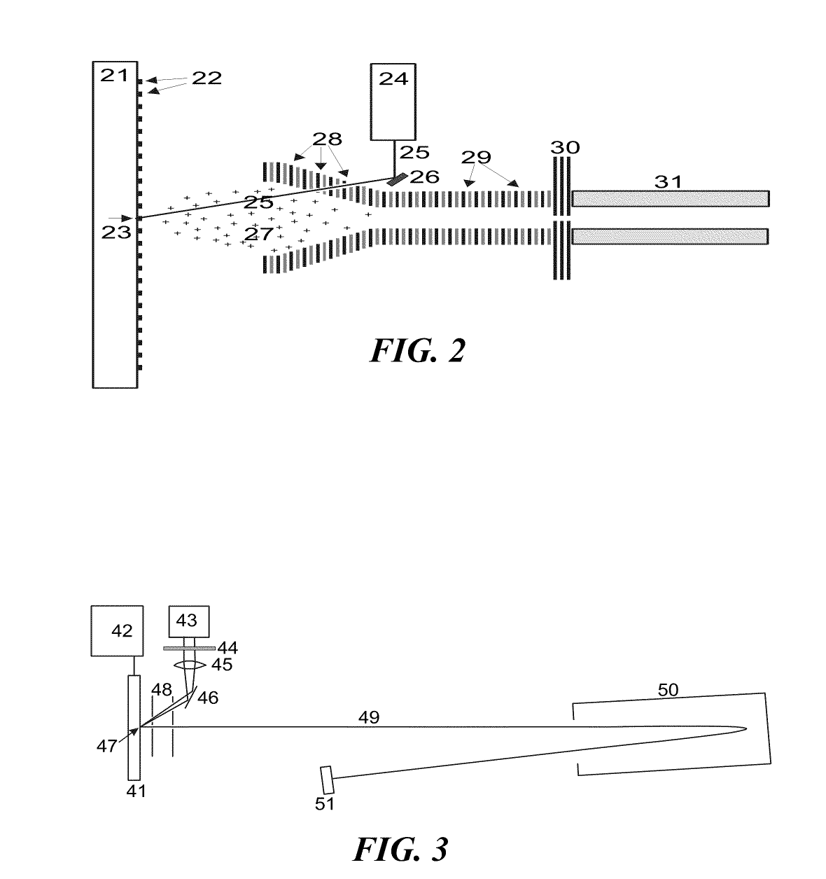

FIG. 2 shows an ion source according to the invention in slightly more detail. The beam guidance for the pulses of laser light (25) is slightly different to FIG. 1: the laser light beam here passes through additional apertures in the apertured diaphragms (28) of the ion funnel. It impacts on the sample (23) on the sample support plate (21), which contains a large number of samples (22, 23) overall. The sample support plate can be made of any material; it is favorable, however, if the sample support plate is electrically conductive, or if a metallic core, a metallic backing or an electrically conducting surface can carry an electric potential, which can be used to create a potential difference between sample support plate (21) and ion funnel (28). Moreover, the sample support plate (21) must be made in such a way that the samples (22, 23) can be firmly held and later desorbed without large lumps of sample breaking off. Samples on the basis of thin layers of the matrix material are favorable. Since the desorption is carried out using laser light, the surface of the sample support plate should be reasonably resistant to ablation by the pulses of laser light. The sample support plate (21) can be moved in two directions parallel to the surface which holds the samples (22, 23), so that all the samples (22, 23) in succession can be brought into the spot of the laser light beam (25). In FIG. 2, the specially labeled sample (23) is in the focus spot of the laser light beam (25).

As is the case with normal vacuum MALDI, the MALDI samples here (22, 23) consist of a coating of matrix substance with a small proportion of analyte molecules, only one hundredth of one percent or so. The dilution means that the analyte molecules are not desorbed in the form of dimers or trimers; this is favorable because, once formed, dimers and trimers will not separate again in the gaseous phase. The task of the matrix substance is therefore to keep the analyte molecules in a finely distributed form on the sample support plate (21); to absorb laser light from the pulse of laser light (25), and thereby desorb the sample material in such a way that the analyte molecules are mostly undamaged and individually transferred, either ionized or neutral, to the gaseous state; and to ionize as large a proportion as possible of the not yet ionized analyte molecules in the plasma cloud by proton transfer from the matrix substance ions to the analyte molecules.

Only a tiny fraction of the sample (23) with preferably less than one picogram of sample material is desorbed in the spot of the laser beam (25) from the laser (24), which is deflected onto the sample (23) by the mirror (26). The lenses required for focusing the beam of laser light to a spot are not shown in FIG. 2. The laser (24) used in this embodiment is preferably a pulsed UV laser, which delivers short pulses of laser light of less than 0.5 picoseconds duration; every pulse of laser light generates its own desorption cloud of analyte ions (27), but their rapid succession leads them to merge together and provide the constant ion current. The UV laser preferably operates in the wavelength range between approximately 310 and 360 nanometers.

The mirror (26) should be movable through very small angles very quickly in order to move the laser light spot over the sample between laser shots. This allows the vaporization crater to cool down again by heat dissipation after each laser shot. The motion can be brought about by gluing the mirror onto a piezoelectric crystal, for example. The piezoelectric crystal can be two-dimensionally excited to its resonance frequencies. The mirror then follows the oscillations and moves the spots at high speed. Moreover, the movement of the sample support plate can contribute to the distribution of the spots over the sample. The use of a mirror with a galvanometric drive is also possible.

The ion funnel (28) consists of a series of apertured diaphragms to which the phases of an RF voltage are applied in turn, thus creating an ion-repelling pseudopotential on the virtual wall of the funnel-shaped interior. A series of DC voltages are superimposed on the RF voltage, which draw the ions into the ion funnel and guides them to its narrow end. At the end, the funnel passes into an ion guide comprising apertured diaphragms (29). The two phases of an RF voltage, on which a DC potential gradient is superimposed, are applied in turn to the apertured diaphragms (29). A lens system (30) then guides the ions into the multipole rod system (31), which guides the ions to the analyzer.

The ion guide (31), which serves here to collect the analyte ions from the ion source according to the invention, is shown here simply as one example of a system which can collect the analyte ions and, if necessary, transmit or temporarily store them. As illustrated in FIG. 2, the ion guide can consist of pole rods supplied with an RF voltage. It can, but does not have to, transmit the analyte ions into the analyzer section of the mass spectrometer, where they are analyzed according to their mass and intensity. Any other suitable type of spectrometer can be used in place of a mass spectrometer for the analysis of the analyte ions, for example an ion mobility spectrometer or an optical spectrometer.

The vaporization of the sample materials in the spots can also take place directly into the axis of a multipole rod system, with the pulse of laser light being injected through the spaces between the pole rods. In this case it has proved favorable to blow a little gas through a capillary onto the sample on the sample support so that a slightly higher pressure of between one hundredth and one tenth of a Pascal is obtained in front of the sample. This increases the yield of analyte ions again.

As already noted above, the conventional matrix substances and methods of preparation can be used to prepare the samples (22, 23). The samples on the sample supports usually have diameters of between 200 micrometers and two millimeters. Pre-prepared thin layers of matrix material are available with diameters of the coatings of 800 micrometers, for example. Thin layers are preferably produced using α-cyano-4-hydroxycinnamic acid (CHCA). The thin-layer coatings are located in regions of the sample support plate that are highly hydrophobic. The samples can then be applied in dissolved form to the thin layers on the sample support plate using pipetting robots and dried in situ, or, better, the liquid can be taken up again after a short time. If thin layers are not used, but instead 2,5 dihydroxybenzoic acid (DHB), sinapic acid (SA) or 3-hydroxypicolinic acid (3-HPA) for example, then special hydrophilic areas on the sample support plate in hydrophobic surroundings can, in particular, limit the sample crystallization to these hydrophilic areas. A large number of matrix substances have been elucidated which are each matched to certain groups of analyte substances which they ionize particularly well.

For imaging mass spectrometry using histologic thin sections, the coating methods for matrix materials developed especially for this technique can also be used. At present, imaging mass spectrometry is mostly carried out with axial MALDI time-of-flight mass spectrometers. The short-time MALDI according to the invention promises improved detection limits with the same duration of the scanning process for recording spectra. Time-of-flight mass spectrometers with orthogonal ion injection are also interesting for this purpose because the scanning of the samples promises to be many times faster than with conventional MALDI time-of-flight mass spectrometry.

The ion sources according to the invention can be used in mass spectrometers of various types, and also in quite different types of spectrometer, for example ion mobility spectrometers. Also of particular interest is, for example, an application as the highly sensitive ion source in a tandem mass spectrometer, which uses a quadrupole filter as the first separation technique and a time-of-flight mass analyzer with orthogonal ion injection (Q-OTOF) as the mass analyzer. This type of mass analyzer has maximum sensitivity, large dynamic measuring range, and an outstanding mass accuracy, also for daughter ion spectra. The fragmentation unit can be either a collision cell or any other fragmentation stage.

This example is only one of many, however. It would also be possible to list additional spectrometric applications here. With knowledge of this invention, the specialist can create further obvious embodiments and applications, which will, however, always be governed by the fundamental idea of the invention and hence should be included in the scope of protection.

What is claimed is:

1. A method for generating analyte ions by matrix-assisted laser desorption of a sample, comprising:
(a) producing a thin layer sample, which contains analyte molecules together with molecules of a matrix substance,
(b) producing with a pulsed UV laser pulses of laser light with a repetition rate of at least twenty kilohertz, each pulse having a pulse duration of less than one nanosecond, and
(c) focusing the pulses of laser light onto at least one spot on the thin layer sample, which spot has a diameter of less than twenty micrometers in order to desorb sample material from the thin layer sample and generate the analyte ions.

2. The method according to claim 1, wherein step (a) comprises providing a matrix substance, which is water-insoluble and forms matrix crystals, and applying a predominantly water-based solution of analyte molecules thereto.

3. The method according to claim 2, wherein the excess water-based solution is removed by suction after thirty seconds to one minute.

4. The method according to claim 2, wherein the analyte molecules are embedded into the matrix crystals by subsequent application of an organic solvent which partially dissolves the matrix crystals after a drying process.

5. The method according to claim 2, wherein a sample support plate is provided, and the thin layer sample is produced in highly hydrophobic regions thereon.

6. The method according to claim 2, wherein the thin layer sample is produced using -cyano-4-hydroxycynnamic acid.

7. The method according to claim 1, wherein step (a) comprises producing the thin layer sample such that it consists of a single layer of closely spaced crystals.

8. The method according to claim 1, wherein step (b) comprises adjusting the laser to produce an energy density in each pulse of laser light so that at most one picogram of sample material is desorbed in step (c) with every pulse of laser light.

9. The method according to claim 1, wherein the diameter of the at least one spot is at most ten micrometers.

10. The method according to claim 1, wherein step (c) comprises simultaneously generating a plurality of spots from each pulse of laser light.

11. The method according to claim 1, wherein step (b) comprises producing the pulses of laser light with a repetition rate of at least fifty kilohertz.

12. The method according to claim 1, further comprising, after step (c) collecting generated analyte ions in an ion funnel located in front of the sample and transmitting the collected ions to an additional apparatus for further processing.

13. The method according to claim 1, further comprising, after step (c) collecting generated analyte ions in a multipole rod system located in front of the sample and transmitting the collected ions to an additional apparatus for further processing.

14. The method according to claim 1, further comprising, after step (c) analyzing the generated ions with a mass spectrometer.

15. The method according to claim 13, wherein the generated ions are analyzed with a time-of-flight mass spectrometer.

16. The method according to claim 1, further comprising, after step (c) analyzing the generated ions with an ion mobility spectrometer.

17. The method according to claim 1, wherein the thin layer sample is a histological thin section.
